(19) United States
(12) Patent Application Publication
(10) Pub. No.: US 2026/0136377 A1
(43) Pub. Date: May 14, 2026

(54) METHOD FOR RESOURCE ALLOCATION IN SIDELINK COMMUNICATION, USER EQUIPMENT, AND CHIP

(71) Applicant: GUANGDONG OPPO MOBILE TELECOMMUNICATIONS CORP., LTD., Dongguan (CN)

(72) Inventor: Huei-Ming LIN, Taipei (TW)

(21) Appl. No.: 19/438,228

(22) Filed: Dec. 31, 2025

Related U.S. Application Data
(63) Continuation of application No. PCT/CN2023/113652, filed on Aug. 18, 2023.

(51) Int. Cl. H04W 72/25; H04W 72/0453

(52) U.S. Cl. CPC H04W 72/25; H04W 72/0453

(57) ABSTRACT

A method for resource allocation between user equipments (UEs) in sidelink (SL) communication includes that: a UE determines a resource allocation within a SL radio carrier or within a SL bandwidth part (BWP) of a carrier, where the resource allocation is associated with a default/anchor frequency portion and/or a primary/special sub-pool. A UE and a chip are also provided.

### CROSS-REFERENCE TO RELATED APPLICATION

The present application is a continuation of International Application No. PCT/CN2023/113652, filed on August 18, 2023, and the entire content thereof is incorporated herein by reference.

### BACKGROUND OF DISCLOSURE

### Field of the Disclosure

The present disclosure relates to the field of communication systems, and more particularly, to a user equipment (UE) and a method for resource allocation between user equipments (UEs) in sidelink (SL) communication and a chip, which can provide a good communication performance and/or provide high reliability.

### DESCRIPTION OF THE RELATED ART

In the advancement of radio wireless transmission and reception directly between two devices, which is often known as device-to-device (D2D) communication, it is first developed by 3rd generation partnership project (3GPP) and introduced in Release 12 (officially specified as sidelink communication) and improved in Release 13 for public safety emergency usage such as mission critical communication to support mainly low data rate and voice type of connection. In 3GPP Releases 14, 15, and 16, the sidelink technology is advanced to additionally support vehicle-to-everything (V2X) communication as part of global development of intelligent transportation system (ITS) to boost road safety and advanced/autonomous driving use cases. To further expand the support of sidelink technology to wider applications and devices with limited power supply/battery, the technology is further enhanced in Release 17 in power saving and transceiver link reliability. For Release 18, 3GPP is currently looking to evolve the wireless technology and expand its operation into unlicensed frequency spectrum. This is for larger available bandwidth, faster data transfer rate, and easier market adoption of D2D communication using sidelink without requiring any mobile cellular operator’s involvement to allocate and configure a part of their expansive precious radio spectrum for data services that do not go throughput their mobile networks.

Therefore, there is a need for a user equipment (UE) and a method for resource allocation between user equipments (UEs) in sidelink (SL) communication, which can solve issues in the prior art and other issues.

### SUMMARY

In a first aspect of the present disclosure, a method for resource allocation between user equipments (UEs) in sidelink (SL) communication includes determining, by a UE, a resource allocation within a SL radio carrier or within a SL bandwidth part (BWP) of a carrier, wherein the resource allocation is associated with a default/anchor frequency portion and/or a primary/special sub-pool.

In a second aspect of the present disclosure, a user equipment (UE) includes a memory, and a processor coupled to the memory. The UE is configured to perform the above method.

In a third aspect of the present disclosure, a chip includes a processor, configured to call and run a computer program stored in a memory, to cause a device in which the chip is installed to execute the above method.

### BRIEF DESCRIPTION OF DRAWINGS

In order to illustrate the embodiments of the present disclosure or related art more clearly, the following figures will be described in the embodiments are briefly introduced. It is obvious that the drawings are merely some embodiments of the present disclosure, a person having ordinary skill in this field can obtain other figures according to these figures without paying the premise.

FIG. 1 is a block diagram of user equipments (UEs) of communication in a communication network system according to an embodiment of the present disclosure.

FIG. 2 is a schematic diagram illustrating a user plane protocol stack according to an embodiment of the present disclosure.

FIG. 3 is a schematic diagram illustrating a control plane protocol stack according to an embodiment of the present disclosure.

FIG. 4 is a flowchart illustrating a method for resource allocation between user equipments (UEs) in sidelink (SL) communication according to an embodiment of the present disclosure.

FIG. 5 is a schematic diagram illustrating a proposed default/anchor frequency portion within a SL radio carrier or within a SL BWP of a carrier, and a primary/special sub-pool for SL RedCap operation according to an embodiment of the present disclosure.

FIG. 6 is a schematic diagram illustrating a proposed a proposed default/anchor BR set within an unlicensed spectrum carrier and a primary/special sub-pool for SL RedCap operation according to an embodiment of the present disclosure.

FIG. 7 is a block diagram of a UE for wireless communication according to an embodiment of the present disclosure.

FIG. 8 is a block diagram of an example of a computing device according to an embodiment of the present disclosure.

FIG. 9 is a block diagram of a system for wireless communication according to an embodiment of the present disclosure.

### DETAILED DESCRIPTION OF EMBODIMENTS

Embodiments of the present disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

### Unlicensed/shared spectrum

Unlicensed/shared spectrum, sidelink communication, back-to-back (B2B) transmission/multi-consecutive slot transmission, unlicensed channel access and occupancy, channel access for multiple unlicensed/shared channels, and mode 2 resource allocation mechanism in sidelink may be configured to implement some embodiments presented herein. The shared (also referred as unlicensed or license-exempted) radio spectrum in 2.4 GHz, 5 GHz, and 6 GHz frequency bands may be used by Wi-Fi and Bluetooth wireless technologies for short range communication (from just a few meters to few tens of meters). The popularity of using the unlicensed radio spectrum is so great that it is often claimed that more traffic is carried over the unlicensed spectrum bands than any other radio bands. The frequency spectrum is free/at no-cost to use by anyone if communication devices are compliant to certain technical regulations set out in each region. Besides Wi-Fi and Bluetooth, other radio access technologies (RATs) such as licensed-assisted access (LAA) based on fourth generation long term evolution (4G-LTE) and new radio unlicensed (NR-U) based on fifth generation new radio (5G-NR) mobile systems from 3rd generation partnership project (3GPP) also operate in the same unlicensed bands. In order for devices of different RATs (Wi-Fi, Bluetooth, LAA, NR-U, and possibly others) to operate simultaneously and coexist fairly in the same geographical area without causing severe interference and interruption to each other’s communication, a clear channel access (CCA) protocol such as listen-before-talk (LBT) adopted in LAA and NR-U and carrier sense multiple access/collision avoidance (CSMA/CA) used in Wi-Fi and Bluetooth are performed before any wireless transmission is carried out to ensure that a wireless radio does not transmit while another is already transmitting on the same channel.

For the sidelink wireless technology to operate and coexist with current RATs operating in the unlicensed frequency bands, LBT based schemes are employed to make certain there is no on-going activity on the radio channel before attempting to access the channel for transmission. For example, when a Type 1 LBT is successfully performed by a sidelink user equipment (UE), the UE has the right to access and occupy the unlicensed channel for a duration of a channel occupancy time (COT). This is called COT initiation. During an acquired COT, however, a device of another RAT could still gain access to the channel if no wireless transmission is performed by the COT initiation sidelink UE or a COT responding sidelink UE for an idle period longer than a pre-defined length (e.g., 16 or 25 µs). Hence, potentially losing the access to the channel until another successful LBT is performed. A potential solution to this issue of losing the access to the channel could be a back-to-back (B2B) transmission.

### B2B transmission/multi-consecutive slot transmission (MCSt)

The main purpose of B2B transmission (which can be also referred as “burst transmission” or “multi-consecutive slot transmission”) may be intended for a sidelink (SL) communicating UE to occupy an unlicensed channel continuously for a longer duration of time (i.e., more than one time slot) to mitigate the risk of losing access to the unlicensed channel to a wireless transmission (Tx) device of another radio access technology (RAT). This B2B transmission can be important and useful for a SL Tx-UE operating in an unlicensed radio frequency spectrum that has a large size of data transport block (TB) or medium access control (MAC) packet data unit (PDU), requires multiple retransmissions, sidelink hybrid automatic repeat request (SL-HARQ) feedback is disabled, and/or with a short latency requirement (small packet delay budget (PDB)). When the unlicensed wireless channel is busy/congested (e.g., with many devices trying to access the channel simultaneously for transmission), it can be difficult and take up a long time to gain access to the channel due to the random backoff timer and priority class category in the LBT procedure. Therefore, when a UE finally has a chance/opportunity to gain access to the wireless channel for a channel occupancy time (COT) length which may last for a few milliseconds (e.g., 2, 4, 6 or 10ms), the intention is to retain the channel access for as long as possible (e.g., all or most of the COT length) to send as much data as possible by continuously transmitting in the unlicensed channel such that wireless devices of other RATs would not have a chance to access the channel.

### Unlicensed channel access and occupancy

A Type 1 LBT procedure can be perform by a UE before any SL transmission to first gain an access to an unlicensed channel and to initiate a COT. Additionally, a B2B transmission could be used to avoid large transmission gaps in order to retain the COT and the access to the channel. Beside the Type 1 LBT, a Type 2 LBT could be also used by the UE within an initiated COT or a shared COT as required by unlicensed spectrum regulation for gaps that are 25 µs or smaller. For example, in a Type 2A LBT if an unlicensed channel is sensed to be idle for 25 µs or more, the COT initiating UE is permitted to resume its transmission and/or a COT sharing UE is allowed to start its transmission within a COT. In a Type 2B LBT, the allowed transmission gap is 16 µs and Type 2C LBT (for which the UE does not need to perform channel sensing) is for gaps less than 16 µs.

In the NR-U and LAA systems, transmission gaps are unavoidable/inevitable before UE occupying the unlicensed channel due to propagation delay between gNB/gNB to the UEs in sending scheduling control information, UE switching from a receiving mode (RX) to a transmitting mode (TX), and data information encoding and modulation for an actual uplink (UL) transmission. Sometimes, these gaps could be larger than 25 µs and an extension of cyclic prefix may be first transmitted in the UL in order to avoid the unlicensed channel being taken over by other devices operating in the same spectrum band due to excessive channel idle time). The duration of the cyclic prefix extension (CPE) transmission in the UL is determined by a base station (gNB/eNB) to avoid any access blocking/denying issue among different UEs and it is indicated to each scheduled UE, and the UE simply follows the indication and performs UL transmission accordingly.

In SL communication, especially in resource allocation (RA) Mode 2, all transmission resources are to be determined and selected by the UE on its own without any base station intervention, assistance, and coordination to avoid transmission collisions. Furthermore, the SL system enables frequency domain multiplexing (FDM) of transmissions from multiple UEs in the same slot such that radio resource utilization efficiency is maximized and shortened the communication latency at the same time. But since there is no base station control and assistance to SL UEs in accessing the unlicensed channel(s), even in RA Mode 1 under a gNB scheduling, the UEs may try to access the channel at different time and using different LBT channel access procedures with different channel idle period requirements. Under this type of operating scenario, it is not possible to coordinate in advanced among the UEs transmitting in the same slot to avoid access blocking/denying to the unlicensed channel.

### Channel access for multiple unlicensed/shared channels

For an unlicensed spectrum band in 5 GHz and 6 GHz frequency range, which are the target unlicensed bands for SL communication, the total bandwidth can be quite large in the order of hundreds of megahertz (MHz). According to unlicensed frequency allocation plans, a block of at least 100 MHz continuous bandwidth is available in most countries. For many applications, the use of a such large bandwidth is not necessary to transmit small packets. Since the design of wireless transmission of most RATs in the unlicensed spectrum is based on a time division multiplexing (TDM) scheme, where one device can transmit at a time, transmitting a small packet but occupying the entire bandwidth would not be a very spectral efficient use of the radio frequency. As such, an unlicensed spectrum band is divided into multiple smaller unlicensed/shared channels, and a wireless transmitting device determines any number of required unlicensed/shared channels and performs listen-before-talk (LBT channel access procedures for the selected unlicensed / shared channels before the transmission. Currently, since 20 MHz is the most common used bandwidth size and one of the smallest bandwidths adopted around the world for the unlicensed/shared channel access, 3GPP adopted the same 20 MHz bandwidth per unlicensed/shared channel definition for the unlicensed bands as the basic unit (a set of resource blocks, RB set) in LAA and NR-U for performing a LBT channel access procedure by eNB/gNB and UE. It is expected the same will be adopted for SL communication in the unlicensed bands as well. In the case when a UE requires more than one unlicensed / shared channel (RB set) for transmission of a large data packet, the UE needs to perform LBT channel access procedure in each one of the required and selected unlicensed channels/RB sets individually. And only when all of the channel access procedures are a success, the UE then gains the access to these channels/RB sets and allows to transmit the large data packet across these multiple channels/RB sets. If any one of the LBT channel access procedure is a failure (e.g., channel is busy), nothing can be transmitted by the UE in these selected multiple channels/RB sets (i.e., even if a success for some of the channels/RB sets).

### Mode 2 resource allocation mechanism in sidelink

In current design of resource allocation mechanism for SL communication, a mode 2 resource selection method relies on the SL transmitting UE to perform autonomous selection of resources on its own from a pool of SL resources for transmission of data packets. In this resource allocation mode, the selection of transmission resources is not random at the start but based on a sensing and reservation strategy to avoid collision with other SL transmission UEs operating in the same resource pool. In this resource selection strategy, a transmitting UE senses the channel for a period of a sensing window (which is different from the LBT channel sensing) to decode and detect information about reservation of SL resources from other transmitting/surrounding UEs. Based on detected resource reservation information, the transmitting UE excludes resources that are already reserved from selection to avoid transmission collision and selects a number of required resources from the remaining/available (non-reserved) ones randomly for its own transmission(s). During the transmissions using the selected resources, likewise, the transmitting UE also sends out/broadcasts its own resource reservation information in the resource pool using sidelink control information (SCI) messages so that other UEs may also avoid collision by not selecting the same or an overlap resource. In the current resource indication and reservation signaling design, the time gap between two consecutive resources for reservation can be up to 31 slots apart.

Besides electrical plug-in terminals, tablets, and smartphones with a decent size of battery, there are currently a few other types of portable communication device with restricted size and constrained form factor that can only equipe with limited battery power to support applications with high processing demand such as glasses, watches, headphones, wrist bands and even bike helmets for vehicle-to-pedestrian (V2P) communication. For these power constrained devices, often due to its size and cost of running, practically they would be also restricted in terms of its wireless transmission (TX) and reception (RX) capabilities. For example, devices operating with 1TX / 1RX antenna, lower bandwidth (BW) support, lower peak data rate and reduced active time in wireless transceiver operation to conserve power.

Unlicensed/shared spectrum, sidelink communication, back-to-back (B2B) transmission/multi-consecutive slot transmission, unlicensed channel access and occupancy, channel access for multiple unlicensed/shared channels, and mode 2 resource allocation mechanism in sidelink as illustrated above may be configured to implement some embodiments presented herein. Further, in some embodiments of the present disclosure, in the present proposed power saving mechanism for UEs with reduced capability in sidelink (SL) communication, a default portion of frequency resources in a SL radio carrier, bandwidth part (BWP) and/or resource pool is allocated as an initial and anchor portion of resources for their SL operation. When a SL UE with reduced capability losses radio link connection with another SL UE, it can be fallback to the initial/anchor portion of resources for receiving messages and (re-)establish a new connection. The initial/anchor portion of resources is also used for synchronization for all SL UEs operating in the same carrier.

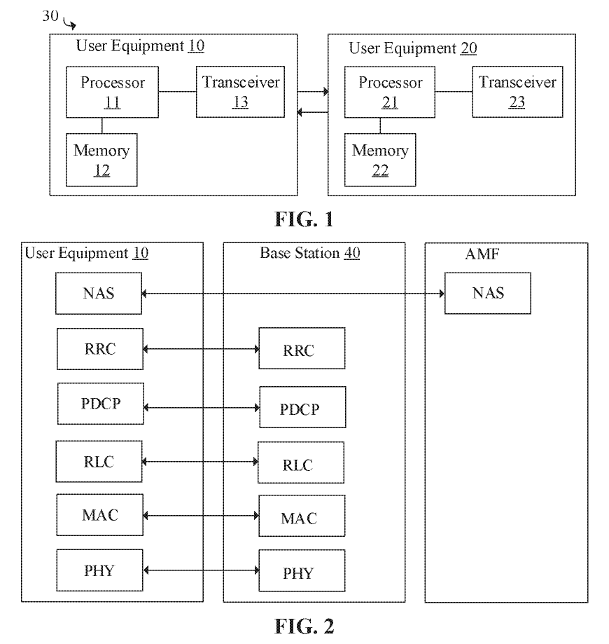

FIG. 1 illustrates that, in some embodiments, one or more user equipments (UEs) 10 (such as a first UE) and one or more user equipments (UEs) 20 (such as a second UE) of communication in a communication network system 30 according to an embodiment of the present disclosure are provided. The communication network system 30 includes one or more UEs 10 and one or more UE 20. The UE 10 may include a memory 12, a transceiver 13, and a processor 11 coupled to the memory 12 and the transceiver 13. The UE 20 may include a memory 22, a transceiver 23, and a processor 21 coupled to the memory 22 and the transceiver 23. The processor 11 or 21 may be configured to implement proposed functions, procedures and/or methods described in this description. Layers of radio interface protocol may be implemented in the processor 11 or 21. The memory 12 or 22 is operatively coupled with the processor 11 or 21 and stores a variety of information to operate the processor 11 or 21. The transceiver 13 or 23 is operatively coupled with the processor 11 or 21 and transmits and/or receives a radio signal.

The processor 11 or 21 may include application-specific integrated circuit (ASIC), other chipset, logic circuit and/or data processing device. The memory 12 or 22 may include read-only memory (ROM), random access memory (RAM), flash memory, memory card, storage medium and/or other storage device. The transceiver 13 or 23 may include baseband circuitry to process radio frequency signals. When the embodiments are implemented in software, the techniques described herein can be implemented with modules (e.g., procedures, functions, and so on) that perform the functions described herein. The modules can be stored in the memory 12 or 22 and executed by the processor 11 or 21. The memory 12 or 22 can be implemented within the processor 11 or 21 or external to the processor 11 or 21 in which case those can be communicatively coupled to the processor 11 or 21 via various means as is known in the art.

The communication between UEs relates to vehicle-to-everything (V2X) communication including vehicle-to-vehicle (V2V), vehicle-to-pedestrian (V2P), and vehicle-to-infrastructure/network (V2I/N) according to a sidelink technology developed under 3rd generation partnership project (3GPP) long term evolution (LTE) and new radio (NR) releases 17, 18 and beyond. UEs are communicated with each other directly via a sidelink interface such as a PC5 interface. Some embodiments of the present disclosure relate to sidelink communication technology in 3GPP NR releases 17 and beyond, for example providing cellular–vehicle to everything (C-V2X) communication.

In some embodiments, the UE 10 may be a sidelink packet transport block (TB) transmission UE (Tx-UE). The UE 20 may be a sidelink packet TB reception UE (Rx-UE) or a peer UE. The sidelink packet TB Rx-UE can be configured to send ACK/NACK feedback to the packet TB Tx-UE. The peer UE 20 is another UE communicating with the Tx-UE 10 in a same SL unicast or groupcast session.

FIG. 2 illustrates an example user plane protocol stack according to an embodiment of the present disclosure. FIG. 2 illustrates that, in some embodiments, in the user plane protocol stack, where service data adaptation protocol (SDAP), packet data convergence protocol (PDCP), radio link control (RLC), and media access control (MAC) sublayers and physical (PHY) layer (also referred as first layer or layer 1 (L1) layer) may be terminated in a UE 10 and a base station 40 (such as gNB) on a network side. In an example, a PHY layer provides transport services to higher layers (e.g., MAC, RRC, etc.). In an example, services and functions of a MAC sublayer may comprise mapping between logical channels and transport channels, multiplexing/demultiplexing of MAC service data units (SDUs) belonging to one or different logical channels into/from transport blocks (TBs) delivered to/from the PHY layer, scheduling information reporting, error correction through hybrid automatic repeat request (HARQ) (e.g. one HARQ entity per carrier in case of carrier aggregation (CA)), priority handling between UEs by means of dynamic scheduling, priority handling between logical channels of one UE by means of logical channel prioritization, and/or padding. A MAC entity may support one or multiple numerologies and/or transmission timings. In an example, mapping restrictions in a logical channel prioritization may control which numerology and/or transmission timing a logical channel may use. In an example, an RLC sublayer may supports transparent mode (TM), unacknowledged mode (UM) and acknowledged mode (AM) transmission modes. The RLC configuration may be per logical channel with no dependency on numerologies and/or transmission time interval (TTI) durations. In an example, automatic repeat request (ARQ) may operate on any of the numerologies and/or TTI durations the logical channel is configured with. In an example, services and functions of the PDCP layer for the user plane may comprise sequence numbering, header compression, and decompression, transfer of user data, reordering and duplicate detection, PDCP PDU routing (e.g., in case of split bearers), retransmission of PDCP SDUs, ciphering, deciphering and integrity protection, PDCP SDU discard, PDCP re-establishment and data recovery for RLC AM, and/or duplication of PDCP PDUs. In an example, services and functions of SDAP may comprise mapping between a QoS flow and a data radio bearer. In an example, services and functions of SDAP may comprise mapping quality of service Indicator (QFI) in downlink (DL) and uplink (UL) packets. In an example, a protocol entity of SDAP may be configured for an individual PDU session.

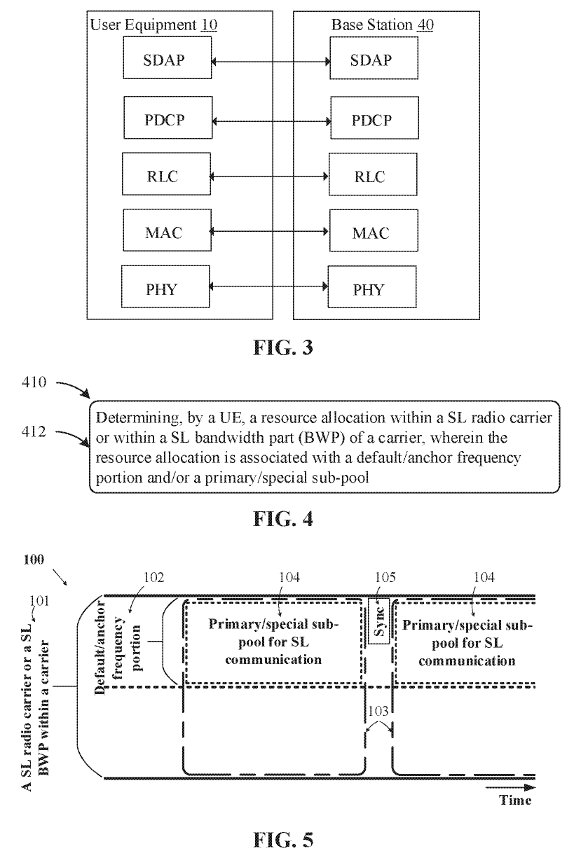

FIG. 3 illustrates an example control plane protocol stack according to an embodiment of the present disclosure. FIG. 3 illustrates that, in some embodiments, in the control plane protocol stack where PDCP, RLC, and MAC layers and PHY layer may be terminated in a UE 10 and a base station 40 (such as gNB) on a network side and perform service and functions described above. In an example, radio resource control (RRC) used to control a radio resource between the UE and a base station (such as a gNB). In an example, RRC may be terminated in a UE and the gNB on a network side. In an example, services and functions of RRC may comprise broadcast of system information related to access stratum (AS) and non-access stratum (NAS), paging initiated by 5G core network (5GC) or radio access network (RAN), establishment, maintenance and release of an RRC connection between the UE and RAN, security functions including key management, establishment, configuration, maintenance and release of signaling radio bearers (SRBs) and data radio bearers (DRBs), mobility functions, QoS management functions, UE measurement reporting and control of the reporting, detection of and recovery from radio link failure, and/or non-access stratum (NAS) message transfer to/from NAS from/to a UE. In an example, NAS control protocol may be terminated in the UE and AMF on a network side and may perform functions such as authentication, mobility management between a UE and an access and mobility management function (AMF) for 3GPP access and non-3GPP access, and session management between a UE and a SMF for 3GPP access and non-3GPP access.

When a specific application is executed and a data communication service is required by the specific application in the UE, an application layer taking charge of executing the specific application provides the application-related information, that is, the application group/category/priority information/ID to the NAS layer. In this case, the application-related information may be pre-configured/defined in the UE. (Alternatively, the application-related information is received from the network to be provided from the AS (RRC) layer to the application layer, and when the application layer starts the data communication service, the application layer requests the information provision to the AS (RRC) layer to receive the information.)

In some embodiments, the processor 11 is configured to determine, by a UE, a resource allocation within a SL radio carrier or within a SL bandwidth part (BWP) of a carrier, wherein the resource allocation is associated with a default/anchor frequency portion and/or a primary/special sub-pool. This can solve issues in the prior art and other others, improve a back-to-back (B2B) transmission, reduce transmission latency, enhance SL resource utilization, and/or improve a sidelink (SL) communication performance.

FIG. 4 illustrates a method 410 for resource allocation between user equipments (UEs) in sidelink (SL) communication according to an embodiment of the present disclosure. In some embodiments, the method 410 includes: an operation 412, determining, by a UE, a resource allocation within a SL radio carrier or within a SL bandwidth part (BWP) of a carrier, wherein the resource allocation is associated with a default/anchor frequency portion and/or a primary/special sub-pool. This can solve issues in the prior art and other others, improve a back-to-back (B2B) transmission, reduce transmission latency, enhance SL resource utilization, and/or improve a sidelink (SL) communication performance.

In some embodiments, one of the UEs in the SL communication includes a reduced/limited capability, and another of the UEs in the SL communication includes the reduced/limited capability or without a capability restriction. In some embodiments, the default/anchor frequency portion and/or the primary/special sub-pool includes at most 5 MHz or 20 MHz of contiguous resources in frequency domain. In some embodiments, determining, by the UE, the resource allocation within the SL radio carrier or within the SL BWP of the carrier further includes configuring a part of frequency resources within the SL radio carrier or the SL BWP to be the default/anchor frequency portion. In some embodiments, the part of frequency resources within an unlicensed/shared carrier is a default/anchor resource block (RB) set. In some embodiments, at least one of SL resource occasions for sidelink-synchronization signaling block (S-SSB) transmission and/or reception is configured in the default/anchor frequency portion. In some embodiments, at least one of SL resource occasions for S-SSB transmission and/or reception is configured in the default/anchor RB set of the unlicensed/shared carrier.

In some embodiments, determining, by the UE, the resource allocation within the SL radio carrier or within the SL BWP of the carrier further includes configuring a part of a SL resource pool within the SL radio carrier or the SL BWP to be the primary/special sub-pool. In some embodiments, the primary/special sub-pool of the SL resource pool is a pool of resources for SL transmission and/or reception. In some embodiments, the method further includes transmitting, by the UE, a signaling or message to another UE configured to indicate one or more reserved resources or RB sets are colliding, not receivable and/or not preferred by the UE. In some embodiments, the method further includes transmitting, by the UE, a signaling or message to another UE configured to indicate at least one preferred resource, frequency portion, RB set, and/or sub-pool for SL communication. In some embodiments, the method further includes receiving, by the UE, a signaling or message from another UE configured to indicate at least one preferred resource, frequency portion, RB set, and/or sub-pool.

In some embodiments, the signaling or message from the another UE is different the signaling or message from the UE for SL communication. In some embodiments, the method further includes performing resource selection or re-selection based on the at least one preferred resource, frequency portion, RB set, and/or sub-pool.

In some embodiments, the signaling or message from the UE and/or the signaling or message from the another UE is transmitted in a physical sidelink feedback channel (PSFCH), a sidelink control information (SCI), a medium access control (MAC) control element (CE), a PC5 radio resource control (PC5-RRC), or a physical sidelink shared channel (PSSCH). In some embodiments, the signaling or message from the UE and/or the signaling or message from the another UE is transmitted as a part of inter-UE coordination information. In some embodiments, the at least one preferred resource, frequency portion, RB set, and/or sub-pool is used for transmitting a PC5-RRC configuration information between the UEs, for setting up a SL unicast session between the UEs, for setting up a PC5-RRC connection between the UEs, for radio link failure (RLF) detection and/or recovery process of a SL unicast session/PC5-RRC connection, for beam failure recovery process, and/or used as a fallback resource, frequency portion, RB set or sub-pool for SL communication between the UEs.

In some embodiments, the term “/” can be interpreted to indicate “and/or.” The term “configured” can refer to “pre-configured” and “network configured”. The term “pre-defined” or “pre-defined rules” in the present disclosure may be achieved by pre-storing corresponding codes, tables, or other manners for indicating relevant information in devices (e.g., including a UE and a network device). The specific implementation is not limited in the present disclosure. For example, “pre-defined” may refer to those defined in a protocol. It is also to be understood that in the disclosure, “protocol” may refer to a standard protocol in the field of communication, which may include, for example, an LTE protocol, NR protocol and relevant protocol applied in the future communication system, which is not limited in the present disclosure.

### Examples:

In the existing/current version of 3GPP sidelink (SL) technology for the direct D2D wireless communication, the basic assumption for the technical design has been assumed that SL user equipment (UE) is equipped with “full capability” or without capability restriction, where a maximum number of transmit (TX) and receive (RX) antennas, highest peak data rate and full channel bandwidth (BW) are assumed to be supported by a SL UE. As such, there is no gap in terms of UE capability in number of supported multiple-input-multiple-output (MIMO) layers, modulation and coding scheme (MCS) and channel BW for monitoring sidelink control information (SCI) and decoding data among SL communication devices.

For a SL UE device with reduced wireless processing capability to achieve power saving or lower power consumption (e.g., via using reduced operating BW, data rate and number of antennas), referred hereafter as a RedCap UE, is operating in a radio channel and communicating with other SL “full capability” UEs and SL RedCap UEs, it would be problematic if their transmission/active portion of the channel BW, MCS used and TX/RX MIMO layers applied are different from each other. SL UE devices would simply not be able to hear and decode one another’s data or even possibly not synchronized to each other.

In order to help and support SL RedCap UEs to operate and communicate with other SL full capability and/or SL RedCap UEs, in some embodiments of the present disclosure of a new SL communication mechanism, it is proposed to define and allocate a portion of frequency spectrum within a radio carrier to be a default/anchor frequency resource and/or a portion of a SL transmission/reception resource pool to be a primary/special sub-pool for SL operation among the UEs.

In one example, when a SL radio carrier has a frequency BW larger than 5 MHz or 20 MHz, a part of the channel BW of the SL carrier or SL bandwidth part (BWP) (e.g., 5 MHz or 20 MHz) can be (pre-)configured/allocated as a default/anchor frequency resource portion for SL communication. The same default/anchor frequency resource portion or a separate frequency resource portion of the SL carrier or SL BWP may be (pre-)configured/allocated with TX and/or RX resources for SL synchronization.

In another example, a SL resource pool can be (pre-)configured with a part of its frequency resources, or both frequency and time resources to be a primary/special portion of the SL resource pool (referred hereafter as a primary/special sub-pool). This portion of the SL resource pool (sub-pool) can be (pre-)configured with contiguous frequency resources of equal to or less than 5 MHz or 20 MHz in bandwidth. This sub-pool can be only used for SL communication (i.e., for transmitting and/or receiving physical sidelink control channel (PSCCH), physical sidelink shared channel (PSSCH), and/or physical sidelink feedback channel (PSFCH)).

In one more example, in an unlicensed/shared radio carrier defined or configured with multiple channels (also known as resource block (RB) sets), one of the channels/RB sets could be (pre-)configured/assigned as a default/anchor RB set for SL communication. The same default/anchor RB set and/or a separate RB set may be (pre-)configured/allocated with TX and/or RX resources for SL synchronization.

In some scenarios, it may combine two or more of the above examples for SL operation.

As exemplary illustrated in Diagram 100 of FIG. 5, a SL radio carrier or a SL BWP within a radio carrier 101 is (pre-)configured/assigned with a part of its channel BW to be a default/anchor frequency portion 102. For SL synchronization, in one example, resources for sidelink-synchronization signal block (S-SSB) transmission and/or reception occasions 105 can be (pre-)configured within the default/anchor frequency portion 102 of the SL carrier, SL BWP or RB set for simplified operation for SL RedCap and full capability UEs, so that no RF switching is involved for SL RedCap UEs between SL communication and synchronization operation. In another example, a SL resource pool 103 that can be used by all UEs (including full capability and RedCap UEs) and overlapped with the default/anchor frequency portion of the SL carrier or SL BWP may be (pre-)configured for SL communication. The frequency portion of the SL resource pool that overlaps with the default/anchor frequency portion of the SL carrier or SL BWP can be (pre-)configured as a primary/special frequency portion or sub-pool 104 designated for SL RedCap UEs to transmit and/or receive PSCCH, PSCCH, and/or PSFCH.

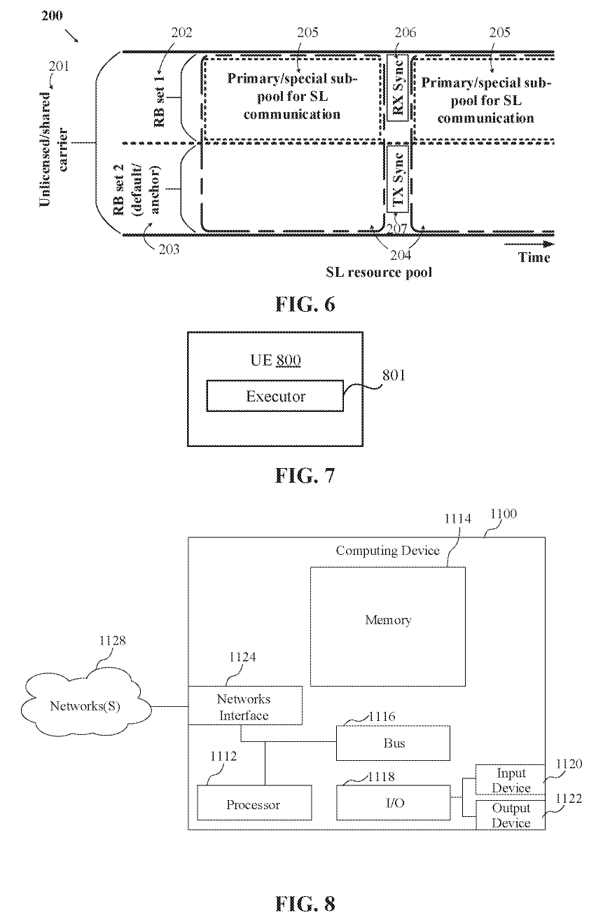

As exemplary illustrated in Diagram 200 of FIG. 6, an unlicensed carrier 201 with multiple channels/RB sets 202 and 203 is (pre-)configured/assigned with one of its channels/RB sets to be a default/anchor RB set 203. For SL synchronization, in one example, the resources for S-SSB transmission occasions 207 could be (pre-)configured in one portion of a SL carrier, SL BWP or RB set (e.g., the default/anchor frequency portion or RB set 203), and the resources for S-SSB reception 206 could be (pre-)configured in another portion of a SL carrier, SL BWP or RB set 202, in order to avoid a half-duplex issue where a SL UE cannot transmit and receive on the same portion at the same time and to create more than one TX/RX S-SSB occasions for different types of UE or UE capabilities.

For example, a S-SSB RX occasion for SL RedCap UEs can be a S-SSB TX occasion for full capability UEs. As illustrated in Diagram 200, a S-SSB RX resource occasion 206 for SL RedCap UE is (pre-)configured in the same RB set 202 as the primary/special sub-pool 205 of the SL resource pool 204, so that the SL RedCap UE monitoring PSCCH/PSSCH/PSFCH (which a UE may be required to perform all the time) does not need to perform RF switching of its receiver circuitry from one RB set to another for receiving S-SSB from other UEs (especially from full capability UEs so that a SL RedCap UE can still be synchronized to full capability UEs operating in the same unlicensed carrier). A S-SSB TX resource occasion 207 for SL RedCap UE, on the other hand, is (pre-)configured in the same RB set as the default/anchor RB set of the unlicensed carrier. By doing so, all SL UEs (including full capability and RedCap UEs) operating in the same common SL resource pool can receive S-SSB transmissions from SL RedCap UEs to achieve SL synchronization. Since SL transmission for SL communication from a RedCap UE is not expected to happen all the time, there would be sufficient time for a SL RedCap UE to perform RF switching of TX circuitry from one RB set to another and back once every 160 ms. As mentioned earlier, this kind of TX and RX resource occasion separation in different RB sets helps to avoid the half-duplex problem for SL RedCap UEs.

For a SL RedCap UE that performs transmission and/or reception of PSCCH, PSSCH, and/or PSFCH only within a restricted channel BW (i.e., in the default/anchor frequency portion of a SL carrier, SL BWP, or default/anchor RB set of an unlicensed carrier, or primary/special sub-pool of a common SL resource pool), in order to communicate with other SL UEs in SL broadcast, groupcast or unicast connections, at least one of the following examples may be applied.

In one example, the SL RedCap UE may send a signaling or message to other UE(s) indicating one or more reserved resources or RB set(s) are colliding, not receivable or not preferred by the SL RedCap UE, such that the other UE(s) may re-select its resource(s).

In another example, the signaling or message to other UE(s) may indicate the receivable, preferred frequency portion, RB set(s) or sub-pool(s) such that their SL broadcast and groupcast transmissions are receivable by the RedCap UE.

In one more example, the signaling or message of receivable / not receivable or preferred/not preferred resources, frequency portion(s), RB set(s) or sub-pool(s) may be transmitted using PSFCH, SCI, medium access control (MAC) control element (CE) or PSSCH. Such signaling or message could be considered as part of an inter-UE coordination.

For a first SL RedCap UE in a SL unicast communication with a second SL RedCap UE within a SL resource pool, at least one of the following examples may be applied.

In one example, the first SL UE may send a signaling or message to the second SL UE indicating one or more frequency portion(s) of a SL carrier or SL BWP, one or more RB set(s) of an unlicensed carrier, and/or one or more sub-pool(s)/frequency portion(s) of the SL resource pool for the SL unicast communication (i.e., including PSCCH, PSSCH, and/or PSFCH transmission and/or reception). The second SL UE may also send a similar signal or message indicating the same, which may or may not be the same frequency portion(s), RB set(s) or sub-pool(s) as indicated by the first SL UE. In both signaling or messages, the indicated frequency portion(s), RB set(s) and/or sub-pool(s) may or may not be the same as the default/anchor frequency portion of the SL carrier, SL BWP, RB set and/or sub-pool of the SL resource pool.

In another example, the signaling or message may be send using PC5 radio resource control (PC5-RRC), MAC CE, SCI or PSSCH. In one example, the default/anchor frequency portion, RB set or sub-pool may be used for sending PC5-RRC (re-)configuration information between two SL UEs, for setting up a SL unicast session between two SL UEs, for setting up the PC5-RRC connection, for radio link failure (RLF) detection and/or recover process of a SL unicast session/PC5-RRC connection, for beam failure recovery process, and/or used as a fallback frequency portion, RB set or sub-pool for SL communication (PSCCH, PSSCH, and/or PSFCH) between the two SL UEs.

FIG. 7 illustrates a UE 800 for wireless communication according to an embodiment of the present disclosure. The UE 800 includes an executor 801 configured to determine a resource allocation within a SL radio carrier or within a SL bandwidth part (BWP) of a carrier, wherein the resource allocation is associated with a default/anchor frequency portion and/or a primary/special sub-pool. This can solve issues in the prior art and other others, improve a back-to-back (B2B) transmission, reduce transmission latency, enhance SL resource utilization, and/or improve a sidelink (SL) communication performance.

In some embodiments, one of the UEs in the SL communication includes a reduced/limited capability, and another of the UEs in the SL communication includes the reduced/limited capability or without a capability restriction. In some embodiments, the default/anchor frequency portion and/or the primary/special sub-pool includes at most 5 MHz or 20 MHz of contiguous resources in frequency domain. In some embodiments, determining, by the UE, the resource allocation within the SL radio carrier or within the SL BWP of the carrier further includes configuring a part of frequency resources within the SL radio carrier or the SL BWP to be the default/anchor frequency portion. In some embodiments, the part of frequency resources within an unlicensed/shared carrier is a default/anchor resource block (RB) set. In some embodiments, at least one of SL resource occasions for sidelink-synchronization signaling block (S-SSB) transmission and/or reception is configured in the default/anchor frequency portion. In some embodiments, at least one of SL resource occasions for S-SSB transmission and/or reception is configured in the default/anchor RB set of the unlicensed/shared carrier.

In some embodiments, determining, by the UE, the resource allocation within the SL radio carrier or within the SL BWP of the carrier further includes configuring a part of a SL resource pool within the SL radio carrier or the SL BWP to be the primary/special sub-pool. In some embodiments, the primary/special sub-pool of the SL resource pool is a pool of resources for SL transmission and/or reception. In some embodiments, the method further includes transmitting, by the UE, a signaling or message to another UE configured to indicate one or more reserved resources or RB sets are colliding, not receivable and/or not preferred by the UE. In some embodiments, the method further includes transmitting, by the UE, a signaling or message to another UE configured to indicate at least one preferred resource, frequency portion, RB set, and/or sub-pool for SL communication.

In some embodiments, the method further includes receiving, by the UE, a signaling or message from another UE configured to indicate at least one preferred resource, frequency portion, RB set, and/or sub-pool. In some embodiments, the signaling or message from the another UE is different the signaling or message from the UE for SL communication. In some embodiments, the method further includes performing resource selection or re-selection based on the at least one preferred resource, frequency portion, RB set, and/or sub-pool. In some embodiments, the signaling or message from the UE and/or the signaling or message from the another UE is transmitted in a physical sidelink feedback channel (PSFCH), a sidelink control information (SCI), a medium access control (MAC) control element (CE), a PC5 radio resource control (PC5-RRC), or a physical sidelink shared channel (PSSCH). In some embodiments, the signaling or message from the UE and/or the signaling or message from the another UE is transmitted as a part of inter-UE coordination information. In some embodiments, the at least one preferred resource, frequency portion, RB set, and/or sub-pool is used for transmitting a PC5-RRC configuration information between the UEs, for setting up a SL unicast session between the UEs, for setting up a PC5-RRC connection between the UEs, for radio link failure (RLF) detection and/or recovery process of a SL unicast session/PC5-RRC connection, for beam failure recovery process, and/or used as a fallback resource, frequency portion, RB set or sub-pool for SL communication between the UEs.

Commercial interests for some embodiments are as follows. 1. Solving issues in the prior art and other issues. 2. Improving a back-to-back (B2B) transmission. 3. Reducing transmission latency. 4. Enhancing SL resource utilization. 5. Improving a sidelink (SL) communication performance. 6. Some embodiments of the present disclosure are used by 5G-NR chipset vendors, V2X communication system development vendors, automakers including cars, trains, trucks, buses, bicycles, moto-bikes, helmets, and etc., drones (unmanned aerial vehicles), smartphone makers, smart watches, wireless earbuds, wireless headphones, communication devices, remote control vehicles, and robots for public safety use, AR/VR device maker for example gaming, conference/seminar, education purposes, smart home appliances including TV, stereo, speakers, lights, door bells, locks, cameras, conferencing headsets, and etc., smart factory and warehouse equipment including IIoT devices, robots, robotic arms, and simply just between production machines. In some embodiments, commercial interest for the disclosed invention and business importance includes lowering power consumption for wireless communication means longer operating time for the device and/or better user experience and product satisfaction from longer operating time between battery charging. Some embodiments of the present disclosure are a combination of “techniques/processes” that can be adopted in 3GPP specification to create an end product. Some embodiments of the present disclosure relate to mobile cellular communication technology in 3GPP NR Releases 17, 18, and beyond for providing direct device-to-device (D2D) wireless communication services.

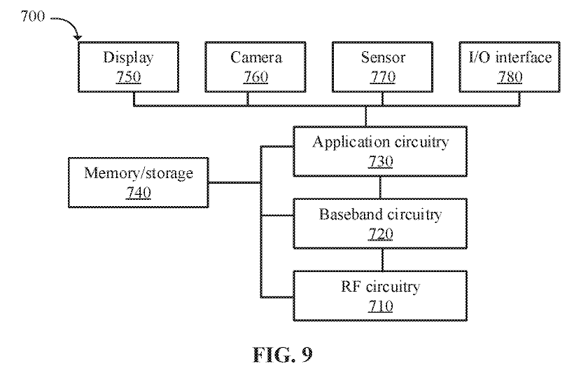

FIG. 8 is a block diagram of an example of a computing device according to an embodiment of the present disclosure. Any suitable computing device can be used for performing the operations described herein. For example, FIG. 8 illustrates an example of the computing device 1100 that can implement some embodiments in FIG. 1 to FIG. 7, using any suitably configured hardware and/or software. In some embodiments, the computing device 1100 can include a processor 1112 that is communicatively coupled to a memory 1114 and that executes computer-executable program code and/or accesses information stored in the memory 1114. The processor 1112 may include a microprocessor, an application-specific integrated circuit (“ASIC”), a state machine, or other processing device. The processor 1112 can include any of a number of processing devices, including one. Such a processor can include or may be in communication with a computer-readable medium storing instructions that, when executed by the processor 1112, cause the processor to perform the operations described herein.

The memory 1114 can include any suitable non-transitory computer-readable medium. The computer-readable medium can include any electronic, optical, magnetic, or other storage device capable of providing a processor with computer-readable instructions or other program code. Non-limiting examples of a computer-readable medium include a magnetic disk, a memory chip, a read-only memory (ROM), a random access memory (RAM), an application specific integrated circuit (ASIC), a configured processor, optical storage, magnetic tape or other magnetic storage, or any other medium from which a computer processor can read instructions. The instructions may include processor-specific instructions generated by a compiler and/or an interpreter from code written in any suitable computer-programming language, including, for example, C, C++, C#, visual basic, java, python, perl, javascript, and actionscript.

The computing device 1100 can also include a bus 1116. The bus 1116 can communicatively couple one or more components of the computing device 1100. The computing device 1100 can also include a number of external or internal devices such as input or output devices. For example, the computing device 1100 is illustrated with an input/output (“I/O”) interface 1118 that can receive input from one or more input devices 1120 or provide output to one or more output devices 1122. The one or more input devices 1120 and one or more output devices 1122 can be communicatively coupled to the I/O interface 1118. The communicative coupling can be implemented via any suitable manner (e.g., a connection via a printed circuit board, connection via a cable, communication via wireless transmissions, etc.). Non-limiting examples of input devices 1120 include a touch screen (e g., one or more cameras for imaging a touch area or pressure sensors for detecting pressure changes caused by a touch), a mouse, a keyboard, or any other device that can be used to generate input events in response to physical actions by a user of a computing device. Non-limiting examples of output devices 1122 include a liquid crystal display (LCD) screen, an external monitor, a speaker, or any other device that can be used to display or otherwise present outputs generated by a computing device.

The computing device 1100 can execute program code that configures the processor 1112 to perform one or more of the operations described above with respect to FIG. 1 to FIG. 7. The program code may be resident in the memory 1114 or any suitable computer-readable medium and may be executed by the processor 1112 or any other suitable processor.

The computing device 1100 can also include at least one network interface device 1124. The network interface device 1124 can include any device or group of devices suitable for establishing a wired or wireless data connection to one or more data networks 1128. Non limiting examples of the network interface device 1124 include an Ethernet network adapter, a modem, and/or the like. The computing device 1100 can transmit messages as electronic or optical signals via the network interface device 1124.

FIG. 9 is a block diagram of an example system 700 for wireless communication according to an embodiment of the present disclosure. Embodiments described herein may be implemented into the system using any suitably configured hardware and/or software. FIG. 9 illustrates the system 700 including a radio frequency (RF) circuitry 710, a baseband circuitry 720, an application circuitry 730, a memory/storage 740, a display 750, a camera 760, a sensor 770, and an input/output (I/O) interface 780, coupled with each other at least as illustrated.

The application circuitry 730 may include a circuitry such as, but not limited to, one or more single-core or multi-core processors. The processors may include any combination of general-purpose processors and dedicated processors, such as graphics processors, application processors. The processors may be coupled with the memory/storage and configured to execute instructions stored in the memory/storage to enable various applications and/or operating systems running on the system.

The baseband circuitry 720 may include circuitry such as, but not limited to, one or more single-core or multi-core processors. The processors may include a baseband processor. The baseband circuitry may handle various radio control functions that enables communication with one or more radio networks via the RF circuitry. The radio control functions may include, but are not limited to, signal modulation, encoding, decoding, radio frequency shifting, etc. In some embodiments, the baseband circuitry may provide for communication compatible with one or more radio technologies. For example, in some embodiments, the baseband circuitry may support communication with an evolved universal terrestrial radio access network (EUTRAN) and/or other wireless metropolitan area networks (WMAN), a wireless local area network (WLAN), a wireless personal area network (WPAN). Embodiments in which the baseband circuitry is configured to support radio communications of more than one wireless protocol may be referred to as multi-mode baseband circuitry.

In various embodiments, the baseband circuitry 720 may include circuitry to operate with signals that are not strictly considered as being in a baseband frequency. For example, in some embodiments, baseband circuitry may include circuitry to operate with signals having an intermediate frequency, which is between a baseband frequency and a radio frequency.

The RF circuitry 710 may enable communication with wireless networks using modulated electromagnetic radiation through a non-solid medium. In various embodiments, the RF circuitry may include switches, filters, amplifiers, etc. to facilitate the communication with the wireless network.

In various embodiments, the RF circuitry 710 may include circuitry to operate with signals that are not strictly considered as being in a radio frequency. For example, in some embodiments, RF circuitry may include circuitry to operate with signals having an intermediate frequency, which is between a baseband frequency and a radio frequency.

In various embodiments, the transmitter circuitry, control circuitry, or receiver circuitry discussed above with respect to the user equipment, eNB, or gNB may be embodied in whole or in part in one or more of the RF circuitry, the baseband circuitry, and/or the application circuitry. As used herein, “circuitry” may refer to, be part of, or include an application specific integrated circuit (ASIC), an electronic circuit, a processor (shared, dedicated, or group), and/or a memory (shared, dedicated, or group) that execute one or more software or firmware programs, a combinational logic circuit, and/or other suitable hardware components that provide the described functionality. In some embodiments, the electronic device circuitry may be implemented in, or functions associated with the circuitry may be implemented by, one or more software or firmware modules.

In some embodiments, some or all of the constituent components of the baseband circuitry, the application circuitry, and/or the memory/storage may be implemented together on a system on a chip (SOC).

The memory/storage 740 may be used to load and store data and/or instructions, for example, for system. The memory/storage for one embodiment may include any combination of suitable volatile memory, such as dynamic random access memory (DRAM)), and/or non-volatile memory, such as flash memory.

In various embodiments, the I/O interface 780 may include one or more user interfaces designed to enable user interaction with the system and/or peripheral component interfaces designed to enable peripheral component interaction with the system. User interfaces may include, but are not limited to a physical keyboard or keypad, a touchpad, a speaker, a microphone, etc. Peripheral component interfaces may include, but are not limited to, a non-volatile memory port, a universal serial bus (USB) port, an audio jack, and a power supply interface.

In various embodiments, the sensor 770 may include one or more sensing devices to determine environmental conditions and/or location information related to the system. In some embodiments, the sensors may include, but are not limited to, a gyro sensor, an accelerometer, a proximity sensor, an ambient light sensor, and a positioning unit. The positioning unit may also be part of, or interact with, the baseband circuitry and/or RF circuitry to communicate with components of a positioning network, e.g., a global positioning system (GPS) satellite.

In various embodiments, the display 750 may include a display, such as a liquid crystal display and a touch screen display. In various embodiments, the system 700 may be a mobile computing device such as, but not limited to, a laptop computing device, a tablet computing device, a netbook, an ultrabook, a smartphone, a AR/VR glasses, etc. In various embodiments, system may have more or less components, and/or different architectures. Where appropriate, methods described herein may be implemented as a computer program. The computer program may be stored on a storage medium, such as a non-transitory storage medium.

A person having ordinary skill in the art understands that each of the units, algorithm, and steps described and disclosed in the embodiments of the present disclosure are realized using electronic hardware or combinations of software for computers and electronic hardware. Whether the functions run in hardware or software depends on the condition of application and design requirement for a technical plan.

A person having ordinary skill in the art can use different ways to realize the function for each specific application while such realizations cannot go beyond the scope of the present disclosure. It is understood by a person having ordinary skill in the art that he/she can refer to the working processes of the system, device, and unit in the above-mentioned embodiment since the working processes of the above-mentioned system, device, and unit are basically the same. For easy description and simplicity, these working processes will not be detailed.

It is understood that the disclosed system, device, and method in the embodiments of the present disclosure can be realized with other ways. The above-mentioned embodiments are exemplary only. The division of the units is merely based on logical functions while other divisions exist in realization. It is possible that a plurality of units or components are combined or integrated in another system. It is also possible that some characteristics are omitted or skipped. On the other hand, the displayed or discussed mutual coupling, direct coupling, or communicative coupling operate through some ports, devices, or units whether indirectly or communicatively by ways of electrical, mechanical, or other kinds of forms.

The units as separating components for explanation are or are not physically separated. The units for display are or are not physical units, that is, located in one place or distributed on a plurality of network units. Some or all of the units are used according to the purposes of the embodiments. Moreover, each of the functional units in each of the embodiments can be integrated in one processing unit, physically independent, or integrated in one processing unit with two or more than two units.

If the software function unit is realized and used and sold as a product, it can be stored in a readable storage medium in a computer. Based on this understanding, the technical plan proposed by the present disclosure can be essentially or partially realized as the form of a software product. Or, one part of the technical plan beneficial to the conventional technology can be realized as the form of a software product. The software product in the computer is stored in a storage medium, including a plurality of commands for a computational device (such as a personal computer, a server, or a network device) to run all or some of the steps disclosed by the embodiments of the present disclosure. The storage medium includes a USB disk, a mobile hard disk, a read-only memory (ROM), a random access memory (RAM), a floppy disk, or other kinds of media capable of storing program codes.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

1. A method for resource allocation between user equipments (UEs) in sidelink (SL) communication, comprising:
determining, by a UE, a resource allocation within a SL radio carrier or within a SL bandwidth part (BWP) of a carrier, wherein the resource allocation is associated with at least one of a default/anchor frequency portion or a primary/special sub-pool.

2. The method of claim 1, wherein at least one of the following applies:
one of the UEs in the SL communication comprises a reduced/limited capability, and another of the UEs in the SL communication comprises the reduced/limited capability or without a capability restriction; or
at least one of the default/anchor frequency portion or the primary/special sub-pool comprises at most 5 MHz or 20 MHz of contiguous resources in frequency domain.

3. The method of claim 1, wherein determining, by the UE, the resource allocation within the SL radio carrier or within the SL BWP of the carrier further comprises:
configuring a part of frequency resources within the SL radio carrier or the SL BWP to be the default/anchor frequency portion.

4. The method of claim 3, wherein at least one of the following applies:
the part of frequency resources within an unlicensed/shared carrier is a default/anchor resource block (RB) set;
at least one of SL resource occasions for sidelink-synchronization signaling block (S-SSB) transmission and/or reception is configured in the default/anchor frequency portion; or
at least one of SL resource occasions for S-SSB transmission and/or reception is configured in the default/anchor RB set of the unlicensed/shared carrier.

5. The method of claim 1, wherein determining, by the UE, the resource allocation within the SL radio carrier or within the SL BWP of the carrier further comprises:
configuring a part of a SL resource pool within the SL radio carrier or the SL BWP to be the primary/special sub-pool.

6. The method of claim 5, wherein the primary/special sub-pool of the SL resource pool is a pool of resources for SL transmission and/or reception.

7. The method of claim 1, further comprising:
transmitting, by the UE, a signaling or message to another UE configured to indicate at least one of the following:
one or more reserved resources or RB sets are colliding;
one or more reserved resources or RB sets are not receivable; or
one or more reserved resources or RB sets are not preferred by the UE.

8. The method of claim 1, further comprising:
transmitting, by the UE, a signaling or message to another UE configured to indicate at least one preferred resource, frequency portion, RB set, and/or sub-pool for SL communication.

9. The method of claim 8, further comprising:
receiving, by the UE, a signaling or message from the another UE configured to indicate at least one preferred resource, frequency portion, RB set, and/or sub-pool, wherein the signaling or message from the another UE is different the signaling or message from the UE for SL communication.

10. The method of claim 8, further comprising:
performing resource selection or re-selection based on the at least one preferred resource, frequency portion, RB set, and/or sub-pool.

11. The method of claim 8, wherein at least one of the following applies:
the signaling or message from the UE and/or the signaling or message from the another UE is transmitted in a physical sidelink feedback channel (PSFCH), a sidelink control information (SCI), a medium access control (MAC) control element (CE), a PC5 radio resource control (PC5-RRC), or a physical sidelink shared channel (PSSCH);
the signaling or message from the UE and/or the signaling or message from the another UE is transmitted as a part of inter-UE coordination information; or
the at least one preferred resource, frequency portion, RB set, and/or sub-pool is used for transmitting a PC5-RRC configuration information between the UEs, for setting up a SL unicast session between the UEs, for setting up a PC5-RRC connection between the UEs, for radio link failure (RLF) detection and/or recovery process of a SL unicast session/PC5-RRC connection, for beam failure recovery process, and/or used as a fallback resource, frequency portion, RB set or sub-pool for SL communication between the UEs.

12. A user equipment (UE), comprising:
a memory; and
a processor coupled to the memory;
wherein the processor is configured to:
determine a resource allocation within a SL radio carrier or within a SL bandwidth part (BWP) of a carrier, wherein the resource allocation is associated with at least one of a default/anchor frequency portion or a primary/special sub-pool.

13. The UE of claim 12, wherein at least one of the following applies:
one of UEs in SL communication comprises a reduced/limited capability, and another of the UEs in the SL communication comprises the reduced/limited capability or without a capability restriction; or
at least one of the default/anchor frequency portion or the primary/special sub-pool comprises at most 5 MHz or 20 MHz of contiguous resources in frequency domain.

14. The UE of claim 12, wherein the processor is further configured to:
configure a part of frequency resources within the SL radio carrier or the SL BWP to be the default/anchor frequency portion.

15. The UE of claim 14, wherein at least one of the following applies:
the part of frequency resources within an unlicensed/shared carrier is a default/anchor resource block (RB) set;
at least one of SL resource occasions for sidelink-synchronization signaling block (S-SSB) transmission and/or reception is configured in the default/anchor frequency portion; or
at least one of SL resource occasions for S-SSB transmission and/or reception is configured in the default/anchor RB set of the unlicensed/shared carrier.

16. The UE of claim 12, wherein the processor is further configured to:
configure a part of a SL resource pool within the SL radio carrier or the SL BWP to be the primary/special sub-pool.

17. The UE of claim 12, wherein the processor is further configured to:
transmit, through a transceiver, a signaling or message to another UE configured to indicate one or more reserved resources or RB sets are colliding, not receivable and/or not preferred by the UE.

18. The UE of claim 12, wherein the processor is further configured to:
transmit, through a transceiver, a signaling or message to another UE configured to indicate at least one preferred resource, frequency portion, RB set, and/or sub-pool for SL communication.

19. The UE of claim 18, wherein the processor is further configured to:
receive, through the transceiver, a signaling or message from the another UE configured to indicate at least one preferred resource, frequency portion, RB set, and/or sub-pool, wherein the signaling or message from the another UE is different the signaling or message from the UE for SL communication.

20. A chip, comprising:
a processor, configured to call and run a computer program stored in a memory, to cause a device in which the chip is installed to execute operations comprising:
determining a resource allocation within a SL radio carrier or within a SL bandwidth part (BWP) of a carrier, wherein the resource allocation is associated with at least one of a default/anchor frequency portion or a primary/special sub-pool.
